(19) United States
(12) Patent Application Publication
(10) Pub. No.: US 2007/0144557 A1
(43) Pub. Date: Jun. 28, 2007

(54) Cleaning method of apparatus for depositing AI-containing metal film and AI-containing metal nitride film

(76) Inventors: Ki-Hoon Lee, Yongin-si (KR); Sang-Jin Lee, Pyungtaek-si (KR); Tae-Wook Seo, Suwon-si (KR)

Correspondence Address: LADAS & PARRY LLP, 224 SOUTH MICHIGAN AVENUE, SUITE 1600, CHICAGO, IL, 60604, US

(21) Appl. No.: 11/507,828

(22) Filed: Aug. 22, 2006

(30) Foreign Application Priority Data
Dec. 27, 2005 (KR) 10-2005-0130271

(51) Int. Cl. B08B 6/00; B08B 9/00

(52) U.S. Cl. 134/1.1; 134/22.1

(57) ABSTRACT

A dry cleaning method for an apparatus for depositing a thin film that deposits an Al-containing metal film and an Al-containing metal nitride film is provided. The method includes maintaining a temperature inside of chamber of the apparatus for depositing a thin film at 430° C. or higher and cleaning the inside of the chamber by supplying a cleaning gas including Cl₂ into the chamber. When it is difficult to maintain the temperature inside the chamber at 430° C. or higher, the method includes cleaning the inside of the chamber by using a cleaning gas including Cl₂ plasma. Accordingly, the apparatus for depositing the thin film that deposits a titanium aluminum nitride (TiAlN) film and a similar type thin film can be effectively cleaned without having remaining products and particles.

### BACKGROUND OF THE INVENTION

1. Field of the Invention

The present invention relates to a method of cleaning an apparatus for manufacturing semiconductor devices, and more particularly, to a dry cleaning method for a chamber of an apparatus for depositing a thin film.

2. Description of the Related Art

Semiconductor devices are generally manufactured through a plurality of unit processes such as an ion implantation process, a thin film deposition process, a diffusion process, a photographing process, and an etching process. The thin film deposition process among the aforementioned processes needs to improve reproducibility and reliability of manufacturing processes for the semiconductor devices.

A thin film of a semiconductor device is formed on a semiconductor substrate by using a sputtering method, an evaporation method, a chemical vapor deposition method, or an atomic layer deposition method. The apparatus for depositing the thin film for performing the aforementioned method generally includes a chamber, a gas line for supplying various gases into the chamber, and a substrate holder unit for holding the semiconductor substrate.

In the thin film forming process using the apparatus for depositing the thin film, reaction products produced while the thin film is formed are deposited not only on a surface of the semiconductor thin film but also on the internal surface of the chamber. Since the apparatus for depositing the thin film for mass production of semiconductors treats a large amount of semiconductor substrates, when the thin film deposition process is performed in the chamber in which the reaction products are deposited, the reaction products are peeled off, thereby producing particles. The aforementioned particles may cause production of poor quality products in the depositing process, thereby reducing a yield of the semiconductor device. Accordingly, the inside of the chamber has to be cleaned after a predetermined time period, or completing depositing processes of a predetermined number of semiconductor substrates.

A method among conventional methods of cleaning the apparatus for depositing the thin film includes exposing the chamber to the air, disassembling the components, cleaning the chamber and each component by using a volatile material such as alcohol, and assembling the chamber, which are performed in that order. However, the aforementioned cleaning method has not been systematically set up, and therefore a time required for cleaning the chamber is lengthened, thereby reducing productivity.

A dry cleaning method among the methods of cleaning the apparatus for depositing the thin film includes removing a deposited material is removed by using a corrosive gas. For example, a gas for cleaning the chamber of the apparatus for depositing the thin film which deposits a silicon layer, a silicon oxide layer, or a silicon nitride layer is a perfluorized compound gas such as hexafluorethane (C₂F₆), octafluoropropane (C₃F₈), octafluorocyclobutane (C₄F₈) and sulfur hexafluoride (SF₆) or nitrogen trifluoride (NF₃), and the cleaning gas is injected into the chamber to remove the aforementioned layer. In case of an apparatus for depositing a thin film for depositing titanium nitride (TiN), a chamber is cleaned by using chlorine trifluoride (ClF₃) gas or by using NF₃ plasma in a remote plasma method.

Recently, a dry cleaning method for titanium aluminum nitride (TiAlN) that is used for a diffusion barrier, electrode, or heating element has been required. Although the TiAlN thin film is similar to the TiN thin film, unlike the TiN layer, when ClF₃ gas is used as the cleaning gas or when NF₃ or fluorine (F₂) gas that contains fluorine is used as the cleaning gas, as shown in FIG. 1, a solid residue that is aluminum fluoride (AlF₃) remains. Accordingly, the chamber is not effectively cleaned. FIG. 1 is a graph of Gibbs free energy versus temperature illustrating phase equilibrium of an Al—F binary system. Even though another cleaning gas is used, according to processing conditions, a large amount of residues and particles may be easily produced, and therefore an effective dry cleaning method for an apparatus for depositing a thin film that deposits TiAlN or similar type thin films is required.

### SUMMARY OF THE INVENTION

The present invention is contrived to solve the above-mentioned problems. It is an object of the present invention to provide a dry cleaning method for an apparatus for depositing a thin film that deposits an Al-containing metal film and an Al-containing metal nitride film.

According to an aspect of the present invention, there is provided a dry cleaning method for an apparatus for depositing a thin film that deposits an Al-containing metal film and an Al-containing metal nitride film, the method comprising: maintaining a temperature inside of a chamber of the apparatus for depositing the thin film at 430° C. or higher; and cleaning the inside of the chamber by supplying a cleaning gas including Cl₂ into the chamber.

According to another aspect of the present invention, there is provided a dry cleaning method for an apparatus for depositing a thin film that deposits an Al-containing metal film and an Al-containing metal nitride film, the method comprising cleaning an inside of a chamber by supplying a cleaning gas including Cl₂ plasma into the chamber.

In the above aspect of the present invention, the Cl₂ plasma is obtained by converting Cl₂ gas into the Cl₂ plasma in a remote plasma method or supplying Cl₂ gas into the chamber in which direct plasma is applied.

In addition, the aforementioned method further comprises purging the inside of the chamber and a gas line, before injecting the cleaning gas. After cleaning the chamber, in order to remove the cleaning gas that remains in the chamber, the inside of the chamber is purged or treated with at least one plasma selected from the group consisting of Ar, N₂, and H₂.

In addition, the methods according to an embodiment of the invention are effective when the Al-containing metal nitride film is titanium aluminum nitride (TiAlN) or tantalum aluminum nitride (TaAlN).

### BRIEF DESCRIPTION OF THE DRAWINGS

The above and other features and advantages of the present invention will become more apparent by describing in detail exemplary embodiments thereof with reference to the attached drawings in which:

FIG. 1 is a graph of Gibbs free energy versus temperature illustrating phase equilibrium of an Al—F binary system;

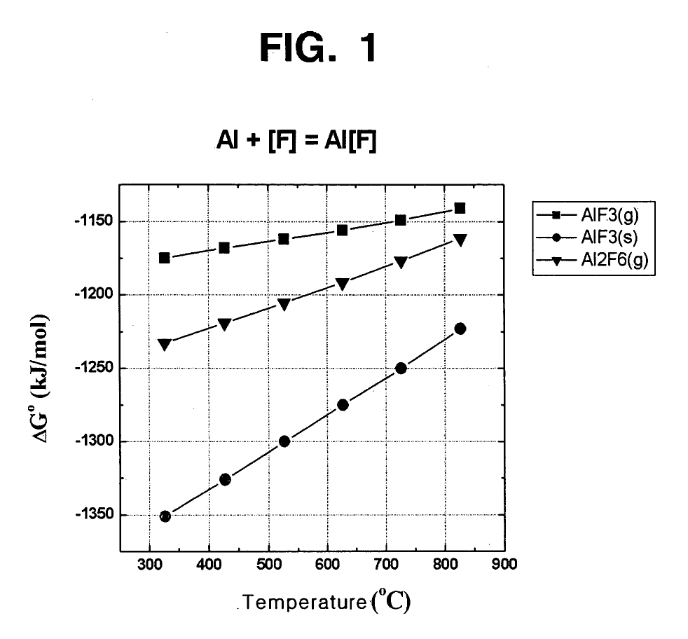

FIG. 2 shows an apparatus for depositing a thin film that is cleaned by a method of cleaning an apparatus for depositing a thin film according to an embodiment of the present invention;

FIG. 3 is a flowchart of a method of cleaning an apparatus for depositing a thin film according to a first embodiment of the present invention;

FIG. 4 is a graph of Gibbs free energy versus temperature illustrating phase equilibrium of a Ti—Cl binary system;

FIG. 5 is a graph of Gibbs free energy versus temperature illustrating phase equilibrium of a Al—Cl binary system; and

FIG. 6 is a flowchart of a method of cleaning an apparatus for depositing a thin film according to a second embodiment of the present invention.

### REFERENCE NUMERALS

10: chamber, 11: shower head, 12: wafer block, 12a: heater

13: pumping baffle, 14: gas curtain block, 20: gas supplying device

100: apparatus (for depositing a thin film)

### DETAILED DESCRIPTION OF THE INVENTION

Hereinafter, exemplary embodiments of the present invention will be described in detail with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

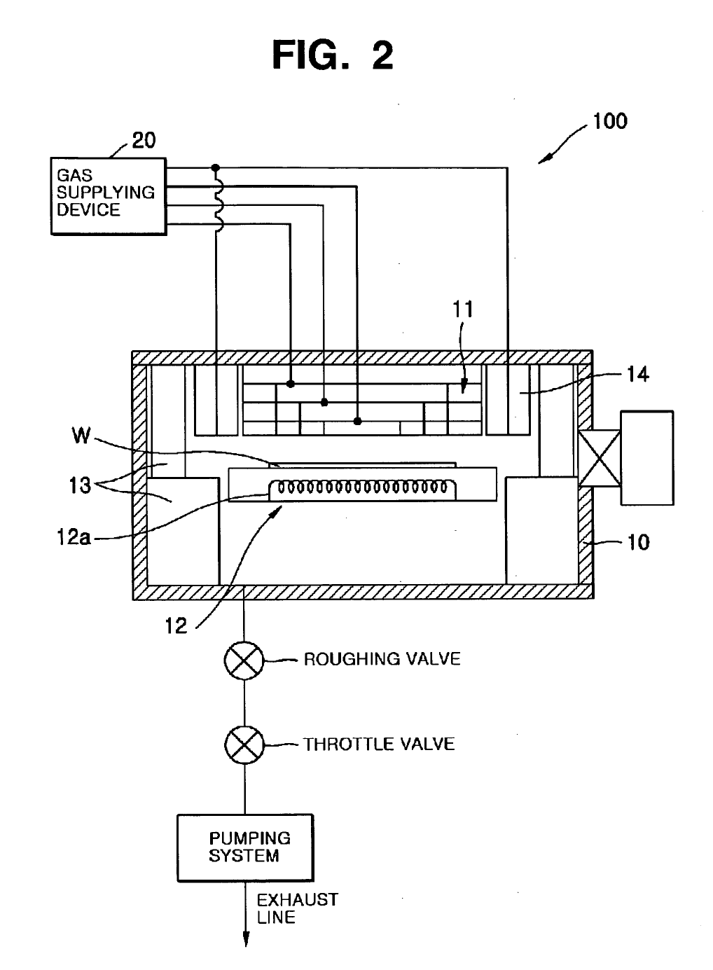

The cleaning method according to an embodiment of the present invention may be applied to clean an apparatus for depositing a thin film as shown in FIG. 2.

An apparatus 100 for depositing a thin film of FIG. 2 is used for depositing an Al-containing metal film or Al-containing metal nitride film on a semiconductor substrate w such as a silicon wafer or glass substrate for liquid crystal display (LCD) that is mounted on a wafer block 12 in a chamber 10. In the present embodiment, the Al-containing metal film is, for example, an Al film, and the Al-containing metal nitride film is, for example, a titanium aluminum nitride (TiAlN) or tantalum aluminum nitride (TaAlN) film.

The apparatus 100 for depositing the thin film includes the chamber 10 in which a thin film is deposited, a gas supplying device 20 that supplies a source gas, an inert gas, and a cleaning gas into the chamber 10 through a gas line. In the cleaning method according to the present embodiment of the invention, the cleaning gas includes Cl₂ or Cl₂ plasma. Accordingly, in order to perform the method according to the present embodiment, the cleaning gas including Cl₂ or Cl₂ plasma is supplied by the gas supplying device 20. The Cl₂ plasma is obtained by converting Cl₂ gas into the Cl₂ plasma in a remote plasma method or supplying Cl₂ gas into the chamber in which direct plasma is applied. Although not shown, a remote plasma generator or direct plasma generator is provided outside the chamber 10. The applied plasma has a power of 50˜2000 W and a low frequency of 300˜500 KHz and/or a high frequency of 13.56 MHz˜21.12 MHz.

The chamber 10 includes a shower head 11 located at an upper portion of the inside of the chamber 10, through which various gases are sprayed, a wafer block 12 located under the shower head 11, on which a semiconductor substrate w is mounted, pumping baffle 13 located at an outer circumference of the wafer block, which is used for effectively and uniformly pumping a source gas, an inert gas, and reaction by-products, and a gas curtain block 14 that sprays an inert gas into the outer circumference of the shower head 11.

A heater 12a is included in the wafer block 12 and heats the mounted semiconductor substrate w to a temperature that ranges from 200° C. to 700° C. The gas curtain block 14 sprays the inert gas into the circumference of the semiconductor substrate w, controls composition variation of the circumference of the semiconductor substrate w, and minimizes contamination of an inner wall of the chamber 10, more particularly, contamination of an inner wall of the pumping baffle 13 caused by sources.

Next, embodiments of a method of cleaning the chamber 10 of the apparatus 100 for depositing the thin film shown in FIG. 2 will be described.

### First Embodiment

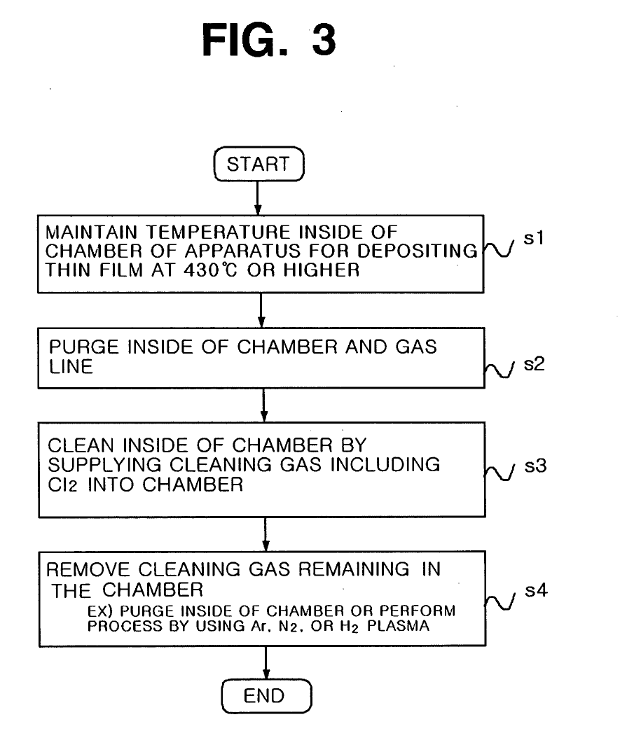

FIG. 3 is a flowchart of a method of cleaning an apparatus for depositing a thin film according to a first embodiment of the present invention.

First, in step s1 shown in FIG. 3, a temperature inside the chamber 10 of the apparatus 100 for depositing the thin film is maintained at 430° C. or higher. For example, temperatures of the shower head 11, the wafer block 12, and the like, which are to be dry cleaned are maintained to be equal to or higher than 430° C.

Then, in step s2, the inside of the chamber 10 and the gas line are purged. This is because a violent reaction may take place or a large amount of particles may be produced when the gas remains in the chamber 10 and the gas line, and subsequently the cleaning gas is supplied into the chamber 10 and the gas line. Step s2 may be omitted when there is not the aforementioned problem. An inert gas, for example, argon (Ar) or nitrogen (N₂) is used as a purge gas.

Alternatively, step s1 and step s2 may be performed in reverse order.

Next, in step s3, the inside of the chamber 10 is cleaned by supplying the cleaning gas including Cl₂ into the chamber 10. A pressure in the chamber 10 may be maintained at 2 Torr, and a flux of the cleaning gas may be about 500 sccm. Although a time needed for step s3 may change according to contamination degree of the chamber 10, 3 to 20 minutes may be suitable for cleaning the chamber 10.

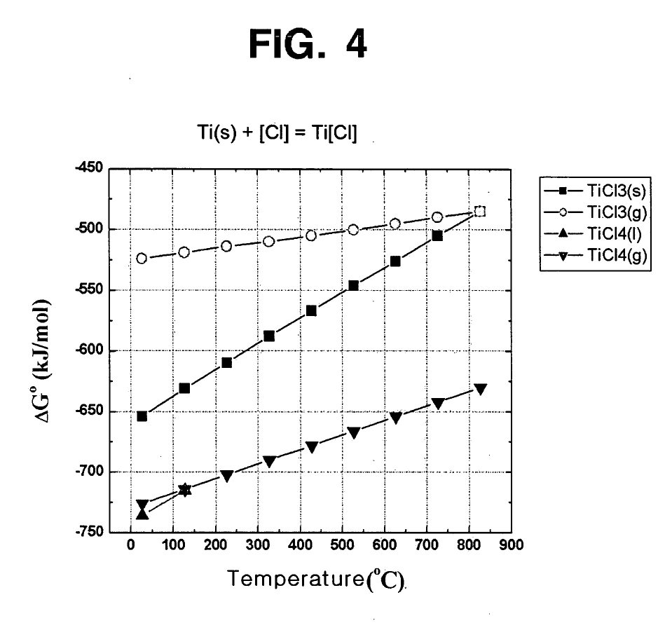

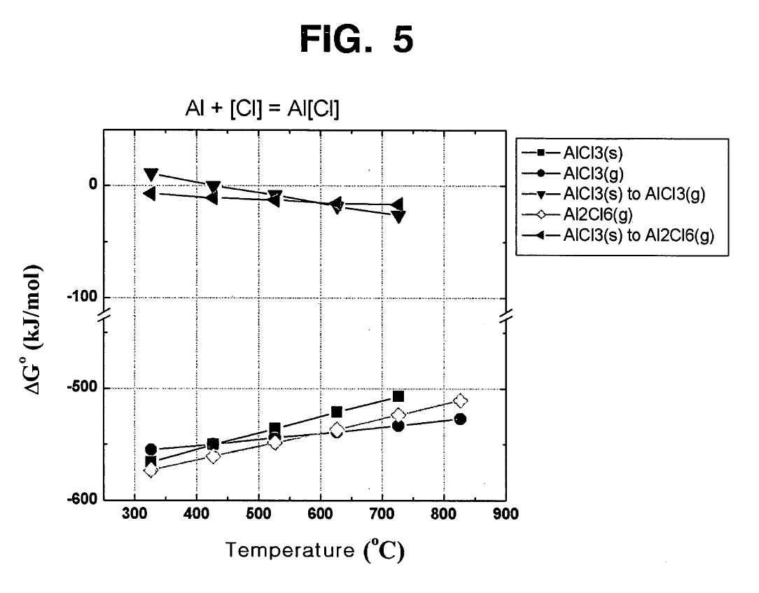

When the apparatus 100 for depositing the thin film is an apparatus that deposits a TiAlN film, titanium (Ti) and aluminum (Al), which are main ingredients of TiAlN, react with chlorine (Cl₂) to produce a stable gaseous reaction product, as shown in the graphs of FIGS. 4 and 5. FIG. 4 is a graph of Gibbs free energy versus temperature illustrating phase equilibrium of a Ti—Cl binary system. FIG. 5 is a graph of Gibbs free energy versus temperature illustrating phase equilibrium of an Al—Cl binary system.

That is, TiAlN may be removed by using Chemical Reaction Equation 1.

TiAlN+(7/2)Cl₂→TiCl₄(g)+AlCl₃(g)+(1/2)N₂ [Chemical Reaction Equation 1]

Since chemical activities of titanium tetrachloride (TiCl₄) (g) and aluminum trichloride (AlCl₃) (g) are strong as shown in FIGS. 4 and 5, the aforementioned reaction is stable. However, it should be noted that AlCl₃(s) is produced at a temperature below 430° C. Accordingly, in step s1, according the embodiment of the invention, the temperature inside the chamber 10 is maintained at 430° C. or higher, thereby preventing production of AlCl₃(s). According to the embodiment of the present invention, the Al-containing metal nitride film such as the TiAlN film that is adhered to the inside of the chamber 10 can be removed by using chlorine (Cl₂) without having a remaining product. An upper limit of the temperature inside the chamber 10 is not limited. In order to improve the cleaning efficiency, a high temperature is advantageous, and however, an appropriate temperature is selected by considering energy, thermal resistance of an interior material of the chamber 10 and the like. The upper limit of the temperature inside the chamber 10 can be suitably selected by those skilled in the art.

After step s3 of cleaning, step s4 of removing the Cl-containing cleaning gas that remains in the chamber 10 is performed. For example, the inside of the chamber 10 is purged for a long time or treated by using plasma of a gas such as hydrogen (H₂) that removes chlorine (Cl₂) or plasma of a gas such as argon (Ar) or nitrogen (N₂) that does not chemically react with any other element but performs sputtering.

### Second Embodiment

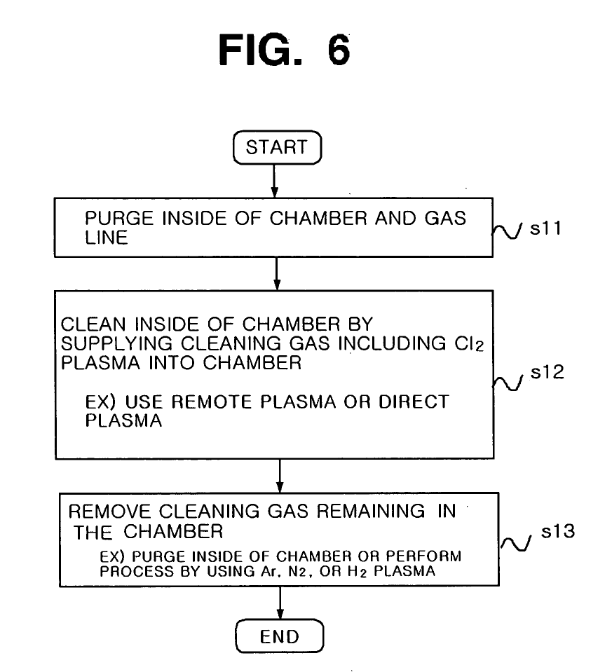

FIG. 6 is a flowchart of a method of cleaning an apparatus for depositing a thin film according to a second embodiment of the present invention.

As described in the first embodiment, the Al-containing metal nitride film such as TiAlN can be removed by using chlorine (Cl₂), and however, AlCl₃(s) that is the remaining product is produced by reacting with aluminum (Al), at a temperature below 430° C. Therefore, it is important that the temperature inside the chamber 10 is maintained at 430° C. or higher. When the temperature inside the chamber 10 can not be raised greater than 430° C., a cleaning gas including Cl₂ plasma is used, as in the present embodiment,

First, as in step s11 of FIG. 6, the inside of the chamber 10 and the gas line are purged. This is because a violent reaction may take place or a large amount of particles may be produced, when the gas remains in the chamber 10 and the gas line, and subsequently the cleaning gas is supplied into the chamber 10 and the gas line. Step s11 may be omitted when there is not the aforementioned problem.

Next, in step s3, the inside of the chamber 10 is cleaned by supplying the cleaning gas including Cl₂ into the chamber 10. Cl₂ plasma is obtained by converting Cl₂ gas into the Cl₂ plasma by a remote plasma method or supplying Cl₂ gas into the chamber in which direct plasma is applied. As described above, when Cl₂ is activated by using plasma, although the temperature inside the chamber 10 is not maintained to be high, the remaining product can be prevented from being produced.

After step s12 of cleaning, step s13 of removing the Cl-containing cleaning gas that remains in the chamber 10 is performed. For example, the inside of the chamber 10 is purged for a long time or treated by using plasma of a gas such as hydrogen (H₂) that removes chlorine (Cl₂) or using plasma of a gas such as argon (Ar) or nitrogen (N₂) that does not chemically react with any other element but performs sputtering.

### EXPERIMENTAL EXAMPLE

Table 1 illustrates results from removing TiAlN by using chlorine (Cl₂) as in the first embodiment. In Experimental Example, a pressure inside the chamber is 2 Torr, and a flux of the cleaning gas (Cl₂) is 500 sccm. The time for supplying chlorine (Cl₂) is 3 to 20 minutes.

TABLE 1

| | | | Thickness of | |
|---|---|---|---|---|
| | | | deposited | Thickness of |
| | | | material | deposited |
| Sample | Cleaning | Temperature and | before | material after |
| number | gas | time condition | cleaning (Å) | cleaning (Å) |
| 1 | Cl₂ | 350° C., 5 minutes | 400 | 153.78 |
| 2 | Cl₂ | 440° C., 3 minutes | 400 | 15.93 |
| 3 | Cl₂ | 440° C., 4 minutes | 400 | 15.2 |
| 4 | Cl₂ | 440° C., 6 minutes | 400.23 | 7.52 |
| 5 | Cl₂ | 440° C., 20 minutes | 387.48 | 9.31 |
| 6 | Cl₂ | 510° C., 6 minutes | 357.27 | 14.36 |

As shown in Table 1, when the temperature inside the chamber is maintained at 430° C. or higher, and the chamber is treated by using Cl₂ (sample numbers 2 to 6), the TiAlN thin film that is adhered to the inside of the chamber can be almost removed. Then, the TiAlN is nearly completely removed at a high temperature (sample numbers 2 to 6), and however, a small amount of the remaining aluminum trichloride AlCl₃ (s) exists (sample number 1).

According to the present invention, it is possible that the apparatus for depositing the thin film that deposits the Al-containing metal nitride film or a similar film such as TiAlN which is used for a diffusion barrier, electrode, or heating element is effectively dry etched. That is, the chamber of the apparatus for depositing the thin film can be effectively cleaned without having remaining products and particles. Therefore, it is possible that an effective mass production is achieved by using the apparatus for depositing the thin film. Accordingly, productivity of semiconductor devices including the Al-containing metal film or Al-containing metal nitride film can be improved.

Although the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A dry cleaning method for an apparatus for depositing a thin film that deposits an Al-containing metal film and an Al-containing metal nitride film, the method comprising:
maintaining a temperature inside of chamber of the apparatus for depositing the thin film at 430° C. or higher; and
cleaning the inside of the chamber by supplying a cleaning gas including Cl₂ into the chamber.

2. The method according to claim 1, further comprising purging the inside of the chamber after the cleaning the inside of the chamber, in order to remove the cleaning gas that remains in the chamber.

3. The method according to claim 1, further comprising treating the inside of the chamber with at least one plasma selected from the group consisting of argon (Ar), nitrogen (N₂), and hydrogen (H₂), after the cleaning the inside of the chamber, in order to remove the cleaning gas that remains in the chamber.

4. The method according to claim 1, wherein the Al-containing nitride film is made of titanium aluminum nitride (TiAlN) or tantalum aluminum nitride (TaAlN).

5. The method according to claim 1, further comprising purging the inside of the chamber and a gas line before injecting the cleaning gas.

6. The method according to claim 5, further comprising purging the inside of the chamber after the cleaning the. inside of the chamber, in order to remove the cleaning gas that remains in the chamber.

7. The method according to claim 5, further comprising treating the inside of the chamber with at least one plasma selected from the group consisting of Ar, N₂, and H₂, after the cleaning the inside of the chamber, in order to remove the cleaning gas that remains in the chamber.

8. The method according to claim 5, wherein the Al-containing nitride film is made of TiAlN or TaAlN.

9. A dry cleaning method for an apparatus for depositing a thin film that and deposits an Al-containing metal film and an Al-containing metal nitride film, the method comprising cleaning an inside of a chamber by supplying a cleaning gas that includes Cl₂ plasma for cleaning the chamber into the chamber of the apparatus for depositing the thin film.

10. The method according to claim 9, wherein the Cl₂ plasma is obtained by converting Cl₂ gas into the Cl₂ plasma by a remote plasma method.

11. The method according to claim 9, wherein the Cl₂ plasma is obtained by supplying Cl₂ gas into the chamber in which direct plasma is applied.

12. The method according to claim 9, further comprising purging the inside of the chamber after the cleaning the inside of the chamber, in order to remove the cleaning gas that remains in the chamber.

13. The method according to claim 9, further comprising treating the inside of the chamber with at least one plasma selected from the group consisting of argon (Ar), nitrogen (N₂), and hydrogen (H₂), after the cleaning the inside of the chamber, in order to remove the cleaning gas that remains in the chamber.

14. The method according to claim 9, wherein the Al-containing nitride film is made of titanium aluminum nitride (TiAlN) or tantalum aluminum nitride (TaAlN).

15. The method according to claim 9, further comprising purging the inside of the chamber and a gas line before injecting the cleaning gas.

16. The method according to claim 15, further comprising purging the inside of the chamber after the cleaning the inside of the chamber, in order to remove the cleaning gas that remains in the chamber.

17. The method according to claim 15, further comprising treating the inside of the chamber with at least one plasma selected from the group consisting of Ar, N₂, and H₂, after the cleaning the inside of the chamber, in order to remove the cleaning gas that remains in the chamber.

18. The method according to claim 15, wherein the Al-containing nitride film is made of TlAlN or TaAlN.
